(19) United States
(12) Patent Application Publication
(10) Pub. No.: US 2005/0087901 A1
(43) Pub. Date: Apr. 28, 2005

(54) Insulation containing a layer of textile, rotary and/or flame attenuated fibers, and process for producing the same

(76) Inventors: Alain Yang, Villanova, PA (US); Mark S. Trabbold, Harleysville, PA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/689,858

(22) Filed: Oct. 22, 2003

(51) Int. Cl. B27N 3/00

(52) U.S. Cl. 264/109; 264/122

(57) ABSTRACT

An insulation product contains a layer of textile, rotary and/or flame attenuated fibers. A process for manufacturing the insulation product includes passing fibrous bundles of one or more of textile fibers and of rotary and/or flame attenuated fibers together through an apparatus that separates the fibers and the mixes the separated fibers. The bundles of rotary and/or flame attenuated fibers can be in the form of specially manufactured mats and/or can be production scraps. The resulting mixture of fibers is formed into a non-woven batt, mat, blanket, or board. The process provides homogeneous fiber product with an improved appearance. The textile fibers can enhance thickness recovery of compressed product. Blends of textile glass fiber with rotary and/or flame attenuated glass fiber exhibit an improved combination of thermal and acoustic insulating performance and adequate strength, at a low production cost.

### BACKGROUND OF THE INVENTION

1. Field of the Invention

This invention relates to fiber insulation. More specifically, this invention relates to thermal and acoustic insulation containing a layer of textile, rotary and/or flame attenuated fibers. This invention also relates to processes for manufacturing the fiber insulation.

2. Description of the Background

Glass and polymer fiber mats positioned in the gap between two surfaces can be used to reduce the passage of heat and noise between the surfaces.

Heat passes between surfaces by conduction, convection and radiation. Because glass and polymer fibers are relatively low thermal conductivity materials, thermal conduction along glass and polymer fibers is minimal. Because the fibers slow or stop the circulation of air, mats of the fibers reduce thermal convection. Because fiber mats shield surfaces from direct radiation emanating from other surfaces, the fiber mats reduce radiative heat transfer. By reducing the conduction, convection and radiation of heat between surfaces, fiber mats provide thermal insulation.

Sound passes between surfaces as wave-like pressure variations in air. Because fibers scatter sound waves and cause partial destructive interference of the waves, a fiber mat attenuates noise passing between surfaces and provides acoustic insulation.

Conventional fiber mats or webs used for thermal and acoustic insulation are made either primarily from textile fibers, or from rotary or flame attenuated fibers. Textile fibers used in thermal and acoustic insulation are typically chopped into segments 2 to 15 cm long and have diameters of greater than 5 μm up to 16 μm. Rotary fibers and flame attenuated fibers are relatively short, with lengths on the order of 1 to 5 cm, and relatively fine, with diameters of 2 μm to 5 μm. Mats made from textile fibers tend to be stronger and less dusty than those made from rotary fibers or flame attenuated fibers, but are somewhat inferior in insulating properties. Mats made from rotary or flame attenuated fibers tend to have better thermal and acoustic insulation properties than those made from textile fibers, but are inferior in strength.

Conventional fiber insulation often contains a non-uniform fiber distribution and fails to provide a satisfactory combination of insulation and strength. Conventional fiber insulation also tends to be expensive. Especially in ductliner applications, a need exists for new, low cost, uniform fiber products with an improved combination of insulation, strength and handling characteristics. Processes to produce these products are also needed.

### SUMMARY OF THE INVENTION

The present invention provides a fiber insulation product including a layer of textile, rotary and/or flame attenuated fibers. A mixture of textile and of rotary and/or flame attenuated fibers results in a low cost insulation product with superior thermal and acoustic insulation properties. The mixed layer can be formed by combining textile fibers and rotary and/or flame attenuated fibers, chopping the combined fibers together to mix and shorten the fibers, and then forming a mat from the mixed fibers. An insulation product of 100% textile glass fibers that is formed by a state of the art air-laid process exhibits better uniformity than conventional textile glass products.

### BRIEF DESCRIPTION OF THE DRAWINGS

The preferred embodiments of the invention will be described in detail, with reference to the following figure, wherein:

FIG. 1 shows a process for manufacturing an insulation product including a mixed layer of textile glass fibers and of rotary and/or flame attenuated glass fibers.

### DETAILED DESCRIPTION OF PREFERRED EMBODIMENTS

In embodiments, the fiber insulation product of the present invention includes a mixed layer of textile fibers and of rotary and/or flame attenuated fibers. In other embodiments, the fiber insulation product of the present invention can be either 100% textile fibers or 100% rotary and/or flame attenuated fibers.

The fibers in the insulation product can form a nonwoven porous structure. The nonwoven fibers can be in the form of a batt, mat, blanket or board. In the mixed layer, the textile fibers and the rotary and/or flame attenuated fibers intermingle. Preferably, the mixed layer is a uniform mixture of the textile fibers and of the rotary and/or flame attenuated fibers. When the insulation product is 100% textile fibers or 100% rotary and/or flame attenuated fibers, preferably the fibers are uniformly distributed in the insulation product in order to offer a constant quality.

The fibers can be organic or inorganic, and natural or man-made. Suitable organic fibers include cellulosic polymer fibers, such as rayon; and thermoplastic polymer fibers, such as polyester or nylon. Natural fibers include cotton, silk, flax and wool. Preferably, the fibers are inorganic. Inorganic fibers include rock wool and glass wool.

Preferably, the fibers are inorganic and comprise a glass. The glass can be, for example, an E-glass, a C-glass, or a high boron content C-glass.

In embodiments, each of the fibers can be made of the same material. In other embodiments with a mixed fiber layer, the textile fibers can be made from one material, and the rotary and/or flame attenuated fibers can be made from a different material. In still other embodiments, different textile fibers can each be made from different materials; and/or different rotary or flame attenuated glass fibers can be made from different materials. Cost and insulation requirements will dictate the selection of the particular materials used in the textile, rotary and flame attenuated fibers. Preferably, the textile fibers are formed from starch coated or plastic coated E-glass. Preferably, the rotary and flame attenuated fibers are formed from high boron C-glass.

Man-made textile, rotary and flame attenuated fibers can be made in various ways known in the art. For example, textile fibers can be formed in continuous processes in which molten glass or polymer is extruded and drawn from apertures to lengths on the order of one mile. For use in insulation, the long textile fibers are divided into short segments by cutting techniques known in the art. Rotary fibers can be made or spun by using centrifugal force to extrude molten glass or polymer through small openings in the sidewall of a rotating spinner. Flame attenuated fibers can be formed by extruding molten glass or polymer from apertures and then blowing the extruded strands at right angles with a high velocity gas burner to remelt and reform the extruded material as small fibers.

The textile fibers used in the insulation product of the present invention have diameters of from greater than 5 μm to about 16 μm. Preferably the textile fibers are divided into segments with lengths of about 2 cm to about 15 cm, more preferably from about 6 cm to about 14 cm. The rotary and flame attenuated fibers have diameters of from about 2 μm to 5 μm. Preferably the rotary and flame attenuated fibers have lengths of about 1 cm to about 5 cm, more preferably from about 2 cm to about 4 cm.

The insulation product according to the present invention can be manufactured in a variety of ways. For example, the mixed layer can be formed by dividing long textile fibers into textile fiber segments, mixing the textile fiber segments with rotary and/or flame attenuated fibers, and depositing the collection of mixed fibers and fiber segments on a surface in a sheet former. Insulation product containing 100% textile fibers or 100% rotary and/or flame attenuated fibers can be similarly formed by dividing fibers into fiber segments and depositing the collection of fiber segments on a surface in a sheet former. The surface of the sheet former can be stationary or moving. Preferably, the surface is provided by a perforated rotating drum, or by a moving conveyor or forming belt. The textile fibers can be divided in various ways known in the art, such as chopping or combing textile fibers.

A binder can be used to capture and hold the fibers in the insulation product together. The binder can be organic or inorganic. The binder can be a thermosetting polymer, a thermoplastic polymer, or a combination of both thermoplastic and thermosetting-polymers. Preferably, the thermosetting polymer is a phenolic resin, such as a phenol-formaldehyde resin, which will cure or set upon heating. The thermoplastic polymer will soften or flow upon heating above a temperature such as the melting point of the polymer. The heated binder will join and bond the fibers. Upon cooling and hardening, the binder will hold the fibers together. When binder is used in the insulation product, the amount of binder can be from 1 to 30 wt %, preferably from 3 to 25 wt %, more preferably from 4 to 24 wt %. The binder can be added to and mixed with the fibers preferably before but also possibly after the processes described above.

In the case of blended textile fibers and rotary and/or flame attenuated fibers, a particularly efficient means of forming the mixed layer involves passing pre-opened fiber nodules of textile fibers and a fibrous mat of rotary and/or flame attenuated fibers together through an apparatus configured to divide the fibers. The fibrous materials can each be either woven or non-woven, but are preferably non-woven. The fibrous mats of rotary and/or flame attenuated fibers can be specially manufactured and/or can include shredded production scrap. In embodiments, only the textile fibers are divided in the fiber dividing apparatus. In other embodiments, both the textile fibers and the rotary and/or flame attenuated fibers are divided in the fiber dividing apparatus. An example of a fiber dividing apparatus is a tearing distribution system in which fibers are torn into fiber segments between interdigitated bars. Another example of such an apparatus is the combination of the above apparatus for rotary mat tearing and a cutting system in which textile fiber is cut by knives into fiber segments. Still another such apparatus is a sucking or depression forming hood. Divided textile and rotary and/or flame attenuated fibers passing through the apparatus are deposited onto a surface to form a mixed layer of textile fiber segments and of rotary and/or flame attenuated fibers. Preferably, the surface is provided by a moving rotating perforated drum, or conveyor or forming belt. The mixed layer can be in the form of a fibrous batt, mat, blanket, or board.

A preferred method of forming the insulation products of 100% textile fibers or of 100% rotary or flame attenuated fibers or of blended fibers is by an air-laid process using a machine sold by DOA (Dr. Otto Angleitner Ges.m.b.H. & Co. KG, A-4600 Wels, Daffingerstasse 10, Austria). In this process every fiber component is finely and individually opened and separated, weighed, and then blended at a desired ratio in a collection of fibers through a pneumatic transportation system to a fiber condenser. From the condenser, the fiber collection is weighed, and then passed through at least one sieve drum sheet former. To supply a binder, a powder binder strewer and weighing device are installed before the last sheet former. The resulting homogenous blend of fibers and binder can have less than 10 wt %, preferably less than 5 wt %, more preferably less than 3 wt % dispersion, based on 0.5 m² sample surface.

Preferably the relative humidity is 40% or greater, more preferably 50% or greater, in the sheet formers when forming the insulation product by an air-laid process such as that using the DOA machine. If the relative humidity is less than 40%, static electricity causes fibers to repel one another, which makes it extremely difficult if not impossible to produce insulation product having homogeneous and uniform fiber dispersions. The static electricity produced in the air-laid process when the relative humidity is less that 40% is surprising, because one would not have expected that under these conditions the friction between fibers and the sieve drum sheet former would have been intense enough to produce the static electricity. This surprising and potentially fatal effect can be overcome or reduced by adding an antistatic agent to the fiber, e.g., by spraying water in with the fiber, by adding an antistatic chemical to the fiber, or by an appropriate selection of binder. After the insulation product is produced in a humid or less static environment, excess water can be removed by heating, e.g., when the binder is cured.

In embodiments, the thickness of the fiber layer of the insulation product of the present invention is preferably in a range from 4 to 250 mm, more preferably from 10 to 205 mm, most preferably from 12 to 76 mm. When the insulation product contains the mixed fiber layer, the percentage of textile fiber in the product can be in a range of 1 to 99%, preferably from 20% to 70% and more preferably from 25% to 50%. The higher the percentage of textile fiber, the stronger the product. However, higher percentages of textile fiber lead to a reduction in acoustic and thermal insulation performance with high cost.

Insulation product produced by a state of the art air-laid process, especially on a DOA machine, exhibits a consistent surface appearance and smoothness, a homogeneous color, and, more surprisingly, a structure of inclined overlaid fiber layers, in particular with 100% textile fiber. This special oriented structure is beneficial for thickness recovery after long storage of the insulation under compression at thicknesses 25% of the nominal thickness or less.

### EXAMPLE

The following non-limiting example will further illustrate the invention.

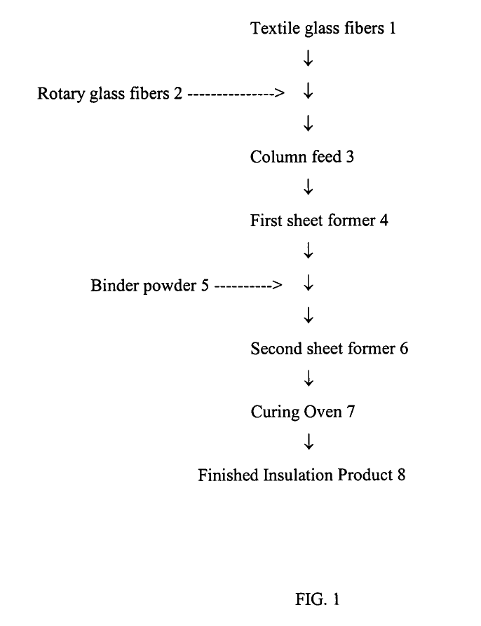

FIG. 1 illustrates various embodiments of the invention. A bale of textile glass fibers and a bale of rotary glass fibers are opened by respective bale openers (not shown). Opened textile glass fibers 1 and opened rotary glass fibers 2 at a desired ratio are conveyed and mixed into a column feed 3. A first sheet former 4 again mixes the fibers, and a binder powder 5 is then added to the combined rotary and textile fibers. The textile fibers 1, rotary fibers 2, and binder powder 5 then enter a second sheet former 6 where the textile and the rotary glass fibers are mixed together with the binder to form a mixture of fibers and binder. The mixture of fibers and binder form a uniform rotary/textile fiber primary mat at the outlet of the second sheet former 6. When the primary mat passes through curing oven 7, the binder powder 5 flows to fix the fibers and form the finished insulation product 8. In embodiments, the rotary glass fibers 2 are not added to the textile glass fibers 1, which results in an insulation product that is 100% textile glass fiber. In other embodiment, the textile glass fibers 1 are not added to the rotary glass fibers 2, which results in an insulation production that is 100% rotary glass fiber. It should be understood from the above description that more than one kind of fiber (e.g., inorganic, organic, natural fibers) can be used in the process at a desired ratio in a similar way.

Table 1 compares tested R-values (index of thermal insulation) and NRC-values (noise reduction coefficient) for a layer made of only textile fibers and a uniform layer of rotary (30%) and textile (70%) fibers. The textile fibers are made from E-glass and the rotary are made from C-glass.

TABLE 1

| Duct-liner Product: | | | |
|---|---|---|---|
| 1.5 pounds per cubic foot, 2.54 cm thick | R-value | NRC | Parting Strength |
| Layer of Textile Fibers only | 3.6 | 0.60 | 5.0 |
| Uniform layer of Rotary (30%) and of Textile | 3.8 | 0.60-0.65 | 4.1 |
| (70%) Fibers | | | |

Table 1 shows that a uniform layer of rotary fibers and of textile fibers provides a higher R-value and a higher NRC value than a layer of only textile fibers, but with lower tensile strength.

While the present invention has been described with respect to specific embodiments, it is not confined to the specific details set forth, but includes various changes and modifications that may suggest themselves to those skilled in the art, all falling within the scope of the invention as defined by the following claims. The disclosure herein of a range with one or two endpoints is a disclosure of all numbers in the range.

1. A method of making an insulation product, the method comprising
passing at least one of a first fibrous material and a second fibrous material through a sheet former at a relative humidity of 40% or more to produce a collection of fibers; and
forming the collection of fibers into a non-woven batt, mat, blanket or board, wherein
the first fibrous material contains first fibers each having a diameter in a range of from greater than 5 μm to about 16 μm; and
the second fibrous material contains second fibers each having a diameter in a range of from about 2 μm to 5 μm.

2. The method according to claim 1, wherein the relative humidity is 50% or more.

3. The method according to claim 1, further comprising adding an antistatic agent to the sheet former while the at least one of a first fibrous material and a second fibrous material passes through the sheet former.

4. The method according to claim 3, wherein the antistatic agent comprises water.

5. The method according to claim 1, wherein
the first fibrous material is passed through the sheet former; and
the first fibers are each about 2 cm to about 15 cm long.

6. The method according to claim 1, wherein
the second fibrous material is passed through the sheet former; and
the second fibers are each about 1 cm to about 5 cm long.

7. The method according to claim 1, wherein at least one of the first fibers and the second fibers comprises a glass.

8. The method according to claim 1, wherein at least one of the first fibers and the second fibers comprises a polymer.

9. The method according to claim 1, wherein the forming comprises
adding a binder to the collection of fibers; and
heating the binder to bond the collection of fibers.

10. A method of making an insulation product, the method comprising
adding an antistatic agent to at least one of a first fibrous material and a second fibrous material;
passing the antistatic agent and the at least one of a first fibrous material and a second fibrous material through a sheet former to produce a collection of fibers; and
forming the collection of fibers into a non-woven batt, mat, blanket or board, wherein
the first fibrous material contains first fibers each having a diameter in a range of from greater than 5 μm to about 16 μm; and
the second fibrous material contains second fibers each having a diameter in a range of from about 2 μm to 5 μm.

11. The method according to claim 10, wherein the relative humidity in the sheet former is 40% or more.

12. The method according to claim 10, wherein the antistatic agent comprises water.

13. The method according to claim 10, wherein
the first fibrous material is passed through the sheet former; and
the first fibers are each about 2 cm to about 15 cm long.

14. The method according to claim 10, wherein
the second fibrous material is passed through the sheet former; and
the second fibers are each about 1 cm to about 5 cm long.

15. The method according to claim 10 wherein at least one of the first fibers and the second fibers comprises a glass.

16. The method according to claim 10, wherein at least one of the first fibers and the second fibers comprises a polymer.

17. The method according to claim 10, wherein the forming comprises
adding a binder that is not the antistatic agent to the collection of fibers; and
heating the binder to bond the collection of fibers.

18. The method according to claim 10, wherein
the antistatic agent comprises a binder; and
the forming comprising heating the binder to bond the collection of fibers.
